(19) United States
(12) Patent Application Publication
(10) Pub. No.: US 2006/0243503 A1
(43) Pub. Date: Nov. 2, 2006

(54) Addition of fuel cell system into motor vehicle

(76) Inventor: Grant B. Carlson, Hammondsport, NY (US)

Correspondence Address: BROWN & MICHAELS, PC;400 M & T BANK BUILDING, 118 NORTH TIOGA ST, ITHACA, NY, 14850, US

(21) Appl. No.: 11/425,501

(22) Filed: Jun. 21, 2006

Related U.S. Application Data
(62) Division of application No. 10/785,342, filed on Feb. 24, 2004.

(51) Int. Cl. B60L 8/00

(52) U.S. Cl. 180/65.3

(57) ABSTRACT

A hybrid fuel cell motor vehicle includes a fuel cell system for powering an electric motor that has its rotor or armature constructed as part of the driveshaft such that the driveshaft can be turned via the electric motor or by the force of an internal combustion engine for the purpose of driving at least one wheel of the vehicle without the need for an interconnecting gearbox or a traction battery.

### REFERENCE TO RELATED APPLICATIONS

The present application claims the benefit of the date of U.S. Provisional Application No. 60/450,446, filed on Feb. 25, 2003, which is incorporated herein.

### BACKGROUND OF THE INVENTION

With the advent of fuel cell systems, there is a desire to use them to power motor vehicles. Automotive manufacturers have recently published commercialization efforts towards the production of fuel cell powered motor vehicles. Experimental fuel cell powered vehicles existence today and mass production of light duty passenger cars powered by fuel cells is planned within the next ten years.

The operation of fuel cells is well known and taught in a number of patents. Some of the more relevant patents are U.S. Pat. No. 4,657,829, by McElroy, et al., issued Dec. 27, 1982 along with U.S. Pat. No. 6,306,532, and U.S. Pat. No. 6,368,735. The PEFL fuel cell is disclosed in U.S. Pat. No. 6,306,532. U.S. Pat. No. 6,368,735 discloses the PEM fuel cell and its operation. The basic operation of fuel cells will not be re-taught here but it should be noted that the technology is constantly evolving.

It is also well understood that electrical power produced from fuel cells is the reverse operation of the electrolysis of water wherein hydrogen and oxygen molecules are combined together to form water and create electrical energy. It is also known that the electrical energy created can be used to drive electric motors. The electric motors can be used to drive wheels to propel the vehicle, thus, the concept of an electric motor vehicle.

U.S. Pat. No. 5,641,031 discloses such an electric vehicle with a fuel cell system and an electric traction motor, where the entire fuel cell system is mounted on a common frame and located in the region of the center of gravity of the vehicle. Others patents like U.S. Pat. No. 5,193,635 and U.S. Pat. No. 6,378,637 and U.S. Pat. No. 5,662,184 all teach similar use but different structural arrangements.

There are several important benefits that come from the use of fuel cells in motor vehicles. One is the reduction of the need for the refinement of crude oil into gasoline brought upon by the replacement of the Internal Combustion Engine (ICE). Other benefits include the reduction of air pollution emissions from the ICE, as the only byproduct of a hydrogen-powered fuel cell is water.

The U.S. Government and automakers are primarily concerned with fuel cells for light duty platforms like GM's Hy-Wire concept vehicle. The focus on small passenger cars ignores the benefits that larger motor vehicles could be afforded if they too had a fuel cell system onboard. However the issues of onboard storage of hydrogen vs. vehicle range in respect to vehicle space constraints are significant issues yet to be resolved for larger vehicles. A Hybrid Fuel Cell Vehicle (HFCV) is created by the combination of a fuel cell system and an Internal Combustion Engine (ICE) in a vehicle.

Some variations of hybrid vehicles are disclosed in U.S. Pat. No. 6,378,638 and in U.S. Pat. No. 6,252,331 (Mildice, et al.). Mildice discloses a hybrid vehicle with an ICE that drives an alternator which then in turn powers an electric motor that is coupled to the vehicle drivetrain. U.S. Pat. No. 6,378,638 discloses a drive axle for use in a hybrid vehicle that includes a small ICE and an electric traction motor. A gearbox is used to join the ICE and the motor together such that either or both can propel the vehicle. The gearbox contains both a sun gear and compound planetary gears. The hybrid vehicle uses a large traction battery to power an electric motor to start the vehicle forward, provide bursts of power for acceleration and then uses the internal combustion engine for maintaining cruising speeds on the highway. The gearbox is used to transfer driving torque to the rear wheels from either the electric motor or the ICE or both. Neither of these patents considers the use of fuel cells to power the vehicle, nor the use of a motor design built about a common driveshaft not requiring an interconnecting gearbox.

A recent U.S. patent application U.S. Ser. No. 10/279,014, publication no.: US 2003/0141122 by Wolf Boll, discloses a hybrid drive system for a passenger car having an ICE and using an Auxiliary Power Unit (APU) to continuously provide charge to a large traction battery, which in turn provides power to an electric motor. The ICE is connected through a clutch to the electric motor in the hybrid system. The motor is then connected to the vehicle's transmission and the output shaft of the transmission turns the wheels of the vehicle. Although APUs are historically small diesel generators, one of the possible configurations of the APU disclosed is a fuel cell system. The disclosure by Boll states that the APU itself cannot provide sufficient power to start the vehicle forward thus a large traction battery is used to provide such peak power. The traction battery and fuel cell system in the APU are also not sufficient to power the vehicle for operation at highway speeds over longer distances. The Traction battery is expensive and requires significant space. Traction batteries have short life spans when compared to the other major components in the hybrid drive system and so need to be replaced. APUs are standalone units and when used in a motor vehicle have redundant system components to those already in the vehicle. Therefore, the hybrid drive system disclosed by Boll is neither practical nor efficient for implementation into vehicles like SUVs, trucks and buses.

About one half of all new vehicles sold last year in the US where medium-duty vehicles like SUVs and light trucks and of them the big three automakers sold nearly 2 million full size pickup trucks. These vehicles typically weight over 5000 lbs. and require large amounts of power for hauling loads, towing and four-wheel operation. Because of the large power demands and limited available space, it is likely these vehicles will be mostly ignored when it comes to the application of fuel cells. Also ignored will be millions of used pickups, SUVs and classic cars that are driven on U.S. highways today. The pointed acceleration, the sound and feel of the ICE in these cars and trucks are considered desirable features. Sports cars of the “Muscle Car Era” of the late 1960's and early 1970's retain remarkably high resale values for these reasons. But all of these vehicles new or used emit high levels of air pollution and deliver poor gas mileage. It would be a desirable feature to implement fuel cells systems into trucks, SUVs and classic cars in harmony with their ICEs. Even larger cargo carrying trucks and buses could benefit from the addition of a fuel cell system to complement their diesel engines. The resulting hybrid fuel cell vehicle would have the advantages of both reduced fuel consumption and reduced highway emissions. For classic cars it would be desirable to retrofit a fuel cell system in such a way that is could later be removed without irreversible effects to the originality of the vehicle.

Therefore the addition of a fuel cell system to the traditional ICE powered motor vehicle is needed. The addition is needed whether the vehicle is a new concept design or has already been manufactured. The addition of a fuel cell system would also benefit recent generations of Hybrid Electric Vehicles like the Toyota Prius, since they use their ICEs to provide traction power for highway driving. It is desirable for the addition of the fuel cell system to have some important features. One important feature is the safety of the vehicle, as the added components should not impair its structural integrity. Also the system should be easy to install, consume little space and done inexpensively. In pre-existing vehicles, the addition should be done without the costs of removing the current engine or transmission. In the case of a classic car, it would be desirable that the addition be easily removed allowing for restoration of the vehicle back to its original condition. It would also be desirable if the fuel cell system and the ICE could use the same fuel for power, whereby only a single fuel tank and distribution system would be needed. It is desirable that the fuel cell system be large enough to power the vehicle at highway speeds and also act as an assist to the ICE at lower speeds. Whether in a new OEM design or in a pre-existing vehicle, a computer controller is needed to control and monitor performance of both systems and to determine when best to direct motive force between the ICE and the fuel cell system. In pre-existing vehicles an additional controller is needed if the vehicle's stock engine controller is inadequate to control both systems. In a newly designed and manufactured vehicle only one controller would be desirable such to reduce cost.

### SUMMARY OF THE INVENTION

The problem is solved by adding a fuel cell system into a traditional ICE powered motor vehicle or Hybrid Electric Vehicle whereby the electric motor (or motors) used in conjunction with the fuel cell system has it's rotor or armature constructed as part of the driveshaft such that the driveshaft can be turned as part of the electric motor or by the force of an internal combustion engine without the need of an interconnecting gearbox or a traction battery. The motor housing is connected to the frame of the vehicle such that the electric motor can provide torque to wheels in order to propel the vehicle. A computer controller (or controllers) would be needed to control operation of the ICE and the fuel cell system. In a retrofit the new driveshaft can be a “bolt in” replacement of a pre-existing vehicle's driveshaft. For simplicity in the preferred embodiment, only a single motor and driveshaft combination is discussed. However other applications using multiple motors and driveshafts are considered with in the scope and intent of the present invention.

### FIELD OF THE INVENTION

This invention relates to the addition of a fuel cell system into a motor vehicle as another method to propel the vehicle. Traditional motor vehicles have internal combustion engines that provide power to turn wheels such to provide traction to propel the vehicle. Internal combustion engines commonly run on gasoline or diesel fuel but can also burn other fuels like ethanol, methanol, propane, and even hydrogen. A Hybrid Fuel Cell Vehicle (HFCV) is created from the addition of a fuel cell system into a vehicle with an internal combustion engine wherein each system can provide traction power to propel the vehicle.

### ADVANTAGES OF THE INVENTION

The advantages of the present invention are that the Hybrid Fuel Cell Vehicle (HFCV) will have greatly reduced fuel consumption and emissions. Traction batteries, typically used in new Hybrid Electric Vehicles would not be needed to power the electric motor. In the HFCV, the Internal Combustion Engine (ICE) will still be required for brisk acceleration and hauling loads, but constant velocity highway operation can be powered solely by the electric motor from the energy provided by the fuel cell. The fuel cell system can assist the ICE under heavy load without the need of an interconnecting gearbox and allow the ICE to shutdown to a low controlled idle when the vehicle is driven at highway speeds. This allows for the ICE in the vehicle to be sized smaller than what would normally be used, thus further reducing fuel consumption and emissions. Because of its simplicity, the fuel cell system could be retrofitted into pre-existing vehicles. Since, the new driveshaft containing the electric motor can be a “bolt-in” replacement of the traditional driveshaft, the motor vehicle could easily be restored back to its original condition.

### BRIEF DESCRIPTION OF THE DRAWING

FIG. 1 is a block diagram of the major components of the Hybrid Fuel Cell Vehicle;

FIG. 2 is a sketch of a 4-pole electric motor showing typical components and location of the driveshaft;

FIG. 3 is a block diagram of a SOFC implementation of FIG. 1.

### DETAILED DESCRIPTION OF THE INVENTION

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

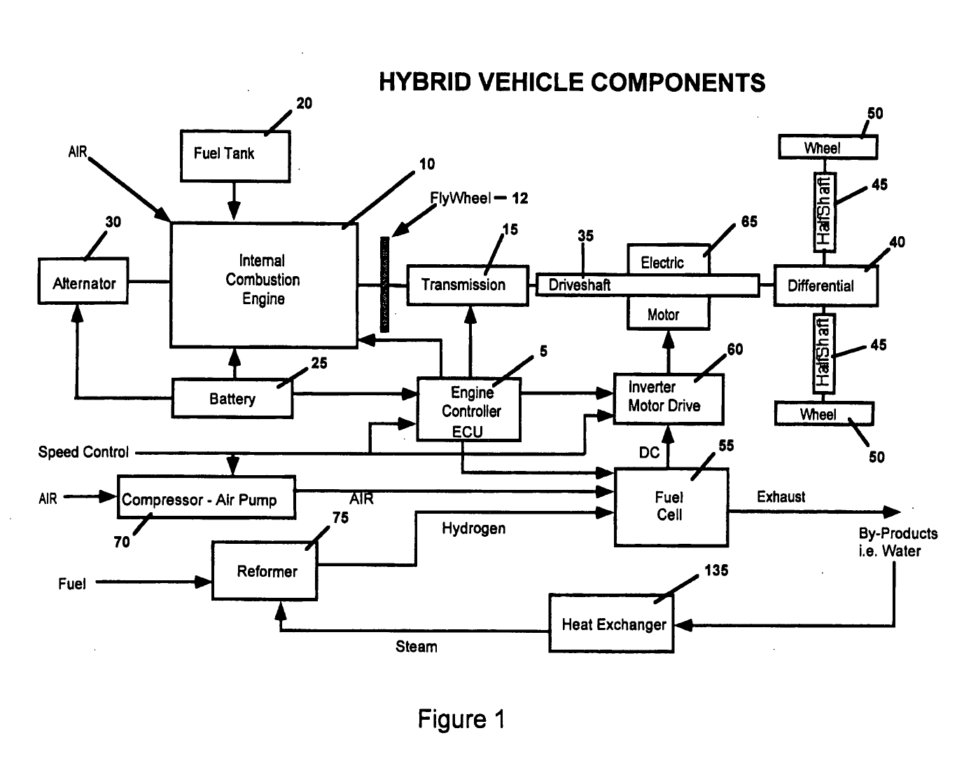

Referring to FIG. 1, the major components of the hybrid vehicle according to the present invention are shown. These components consist of those of a traditional motor vehicle and those added components of a fuel cell system.

The major components of the traditional vehicle are: the Engine Controller Unit (ECU) 5, the Internal Combustion Engine 10, the Flywheel 12, the Transmission 15, the Fuel tank 20, the Battery 25, the Alternator 30, the main Driveshaft 35, the transaxle or Differential 40, the transaxle driveshafts or Half-Shafts 45, and the Wheels 50. In older vehicles that do not have fuel injection, the ECU 5 may not be present.

The major components of a fuel cell system are the Fuel Cell 55, the Inverter 60, the Electric Motor 65 (that also uses the Driveshaft 35 as its rotor), the Air Compressor 70 and the Reformer 75, which is optional. If the hybrid vehicle stores hydrogen in a hydrogen fuel tank for direct use by the fuel cell then the Reformer 75 is not needed. An additional component—a Heat Exchanger 135 is needed if the fuel cell system is to be powered by a hydrocarbon (fossil) fuel. The Heat Exchanger 135 is needed to turn water into steam and provide the steam to the Reformer 75, as steam is needed in the reforming process. Instead of the vehicle carrying a separate heater, the Heat Exchanger 135 can get its heat from the Internal Combustion Engine 10. Also, so that the vehicle does not have to carry its own water, the Heat Exchanger 135 can be fed recovered water from the by products of the Fuel Cell 55. It should be appreciated that only the major components of the hybrid fuel cell vehicle are shown in FIG. 1 and that the method and principles of the preferred embodiment of the invention are applicable to a wide variety of fuel cell system and drivetrain configurations, i.e. using multiple motors on multiple driveshafts or using single or multiple speed transmissions.

As shown in FIG. 1 the ECU 5, which is often, already in place in a traditional vehicle is coupled to the Battery 25 for power and connected via a signal bus to the Internal Combustion Engine (ICE) 10. The ECU 5 is usually also connected to the exhaust system of the ICE 10 (not shown), to the Transmission 15 and to other sensors that monitor water temperature and oil pressure (also not shown). An additional connection from the ECU 5 to the Fuel Cell 55 is also shown. The ECU 5 is useful in monitoring both the correct amount of flow of air and fuel needed by the Fuel Cell 55. The ECU 5 can also be used to monitor the Inverter 60 such that a balance between energy demands required by the vehicle vs. needed motor torque and the required air and fuel flow for the Fuel Cell 55 can best be met. The ECU 5 would also determine based on operating conditions when the vehicle would best be powered by the fuel cell system or by the ICE or both and assist or signal the driver of the vehicle in making the transition if necessary.

The Alternator 30, Battery 25, ICE 10, Flywheel 12, and Transmission 15 all operate as they normally would in the pre-existing vehicle. The transmission 15 when powered by the ICE 10 connects via a Driveshaft 35 to a Differential 40, which in turn splits the driving torque to power the Wheels 50 via the Half-Shafts 45. Note, other drivetrain configurations like for four wheel drive vehicles, are considered within the scope and intent of the present invention.

The fuel cell system can assist the ICE 10 while under heavy loads or at low speed but once the vehicle has accelerated to a cruising speed, the complete transfer of motive power from the ICE 10 to that of the fuel cell system can occur. Since motor vehicles, when cruising, require much less power than needed for brisk acceleration, the fuel cell system is therefore quite small. This small system (generally about 30 KW for a light duty truck and 100 KW for a bus) reduces the likelihood of major body modifications. The fuel cell system consists of a Fuel Cell 55, Inverter 60 and Electric Motor 65. The Fuel Cell 55 can either obtain Hydrogen from a Hydrogen storage tank (not shown) or from the process of reformation on a hydrocarbon fuel. The Reformer 75 and Heat Exchanger 135 would be required for those systems that wish to use the same hydrocarbon fuel as is used to power the ICE 10. The use of Solid Oxide Fuel Cells (SOFC) as the main component in the fuel cell system would be very beneficial as SOFCs require very little or no fuel reformation. A SOFC is constructed entirely of solid-state materials, utilizing an oxygen ion conductive oxide ceramic as the electrolyte. An Air Compressor 70 is also required to supply a sufficient source of oxygen to the Fuel Cell 55. An exhaust system (not shown) for the Fuel Cell 55 is useful in directing by-products of the process both away from the vehicle in a controlled manner and/or in recycling the by-products for other uses by the ICE, the fuel cell system or by other systems in the motor vehicle.

In the case of a retrofit to a pre-existing vehicle, the ICE would likely remain on during highway speeds in at least an idle condition while the fuel cell system is operating. Thus energy needed in the reformation of the hydrocarbon fuel could be obtained from the ICE 10. For example in the Heat Exchanger 135, steam could be created by passing water over or near the hot exhaust system of the ICE 10. In the case where a SOFC system is used, the exhaust from the ICE can provide some if not all of the necessary heat required for operation of the SOFC. Also the rotating crankshaft of the ICE 10 could provide energy needed to drive the Air Compressor 70. It is also possible that the Alternator 30 could be used to provide energy needed for the electrolysis of water. Or the Electric Motor 65 could be used as a generator for the same or other purposes—even possibly to replace the Alternator 30. The fuel cell system itself could replace the Alternator 30 as well.

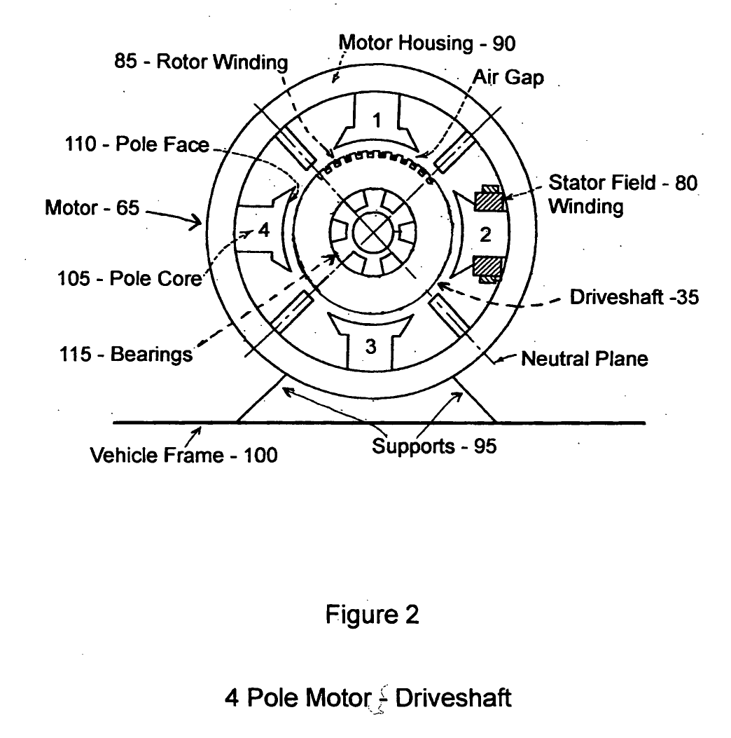

An important attribute of the present invention is the unique operation of the Electric Motor 65 working in common with the Driveshaft 35. The Driveshaft 35 in a traditional vehicle is designed and constructed in such manner as to deliver torque from the ICE 10 through to the Wheels 50. When adding the fuel cell system, a new driveshaft, would be installed that has its rotor windings placed in the Driveshaft 35. The new driveshaft and motor combination is shown in FIG. 2. The motor could be of many different designs. A typical AC motor configuration is shown in FIG. 2. The Stator Windings 80 in the Electric Motor 65 and Rotor Windings 85 in the Driveshaft 35 allow for the vehicle to be driven by the Fuel Cell 55. The new driveshaft is also designed and constructed in such a manner as to properly deliver torque from the ICE 10 through to the Wheels 50 when the fuel cell system is off. Other parts of a typical 4 pole AC motor design are shown in FIG. 2. It should be noted that the motor could be constructed with permanent magnets or could be designed using other kinds of configurations either AC or DC with any number of poles. The Pole Face 110 with Pole core 105 is connected to the Motor Housing 90. The Bearings 115 connected about the Driveshaft 35 supports the Motor Housing 90.

One of the useful features of the Electric Motor 65 and Driveshaft 35 combination is the simplicity in which this configuration can be retrofitted into a traditional motor vehicle. Most all driveshafts in ICE powered cars are hollow tubes of metal, (usually made of either steel or aluminum) with universal joints at one or both ends. Driveshafts are generally constructed in such manner that they can be unbolted from vehicle without the expense of having to remove any other major component like the ICE 10 or the Transmission 15. The new motor and driveshaft combination can make use of the space around the old driveshaft as well as the hollow space within it in order to execute the design without requiring significant modifications to the body of the vehicle. Additional modifications required would be to locate and place the other fuel cell system components in the vehicle and to properly connect the Motor Housing 90 through Supports 95 to the Vehicle Frame 100. Lastly, connections from the ECU 5 to the fuel cell system and a speed control (throttle) connection would complete the major modifications.

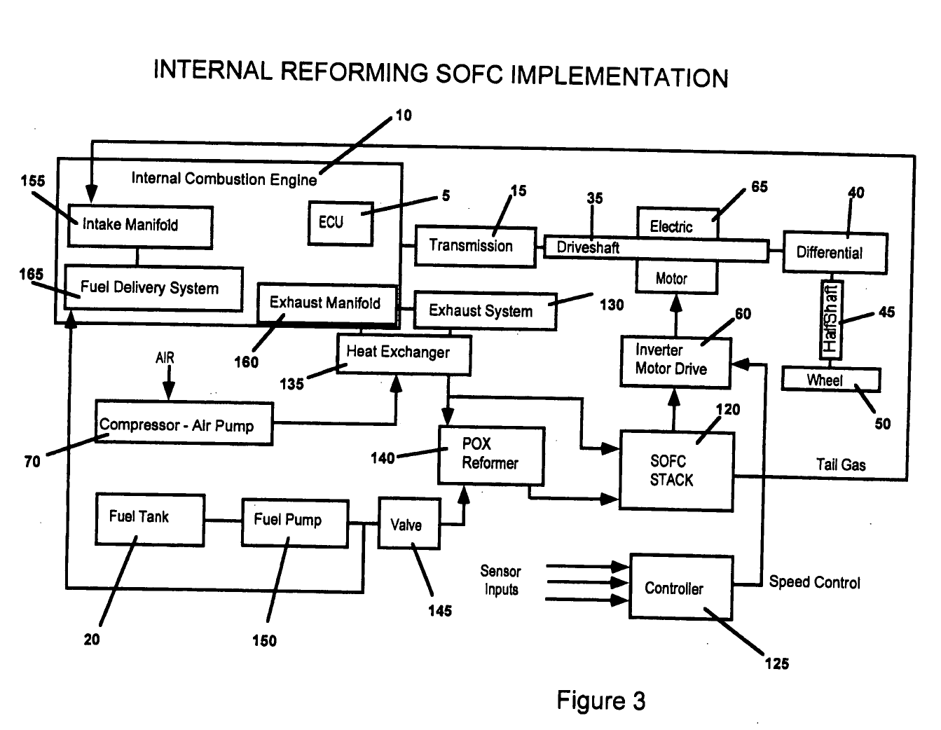

SOFCs have significant advantages when used in the fuel cell system. An example block diagram of a SOFC system implementation is shown in FIG. 3. SOFCs can burn the same hydrocarbon fuel as used by the ICE 10 with little reformation. The result is a significant reduction in system complexity. A POX (Partial Oxidation) Reformer 140 performs simple fuel reformation using heat from the Heat Exchanger 135. A Fuel Pump 150 pumps fuel from the Fuel Tank 20 to the Fuel Valve 145. The fuel is metered by the Fuel Valve 145. The Fuel Pump 150 also sends fuel as it normally would to the engine's Fuel Delivery System 165 where the fuel is vaporized in the Intake Manifold 155.

In FIG. 3, an additional Computer Controller 125 is shown, as the ECU 5 may not always be useful to monitor and control both systems. The ECU 5 and Controller 125 are coupled to the vehicle's battery (typically 12 Volts DC), and those connections are not shown. The ECU 5 is generally connected to the Transmission 15 (connection not shown) and to sensors that monitor water temperature and oil pressure (also not shown) as well as an oxygen sensor in Exhaust System 130 (also not shown).

The Computer Controller 125 is used to monitor the SOFC stack 120 and monitor the correct amount air, fuel and heat as needed by the SOFC stack 120. The Controller 125 monitors other sensor inputs, in specific, throttle position and engine RPMs. The Controller 125 sends a signal to the Inverter or Motor Drive 60 to control the speed of the Electric Motor 65. Also the Controller 125 determines both air and fuel flow needs for the SOFC Stack 120. The Controller 125 is connected to the Air Compressor 70 to regulate the flow of air if needed. The Alternator 30 (not shown), Battery 25 (not shown), ICE 10, Flywheel 12 (not shown), and Transmission 15 all operate as they normally would in a traditional vehicle. The Transmission 15 when powered by the ICE 10 connects via a Driveshaft 35 to a Differential 40, which in turn splits the driving torque to power the Wheels 50 via the Half-Shafts 45. Other drivetrain configurations relating for example to the location of the Electric Motor 65 in the vehicle are considered within the scope and intent of the present invention.

If needed an Air Compressor 70 is used to supply a sufficient source of oxygen to the SOFC Stack 120. An Exhaust System 130 connected to an Exhaust Manifold 160 can be used to provide process heat required for operation of the POX Reformer 140. The exhaust from the ICE can also provide some if not all of the necessary heat required for operation of the SOFC Stack 120. As was previously described for FIG. 1, an important attribute of the present invention is the operation of the Electric Motor 65 working in common with the Driveshaft 35. The Driveshaft 35 is designed and constructed in such a manner as to properly deliver torque from the ICE 10 through to the Wheels 50 when the fuel cell system is not available. Tail gas exhausted from the SOFC Stack 120 is shown routed back to the ICEIO for further improvements in system efficiency and reduced emissions.

The invention has been described in detail with particular reference to certain preferred embodiments thereof, but it will be understood that variations and modifications can be effected within the spirit and scope of the invention.

### PARTS LIST

5 Engine Control Unit (ECU)
10 Internal Combustion Engine (ICE)
12 Flywheel
15 Transmission
20 Fuel Tanks
25 Battery
30 Alternator (Generator)
35 Driveshaft
40 Differential
45 Half-shaft
50 Wheel
55 Fuel Cell
60 Inverter
65 Electric Motor
70 Air Compressor
75 Reformer
80 Stator Winding
85 Rotor Winding
90 Motor Housing
95 Supports
100 Vehicle Frame
105 Pole Core
110 Pole Face
115 Motor Bearings
120 SOFC Stack
125 Additional Controller
130 Exhaust System
135 Heat Exchanger
140 POX Reformer
145 Fuel Valve
150 Fuel Pump
155 Intake Manifold
160 Exhaust Manifold
165 Fuel Delivery System

1-18. (canceled)

19. A method of retrofitting a vehicle having an internal combustion engine, transmission, driveshaft, driven wheel, and fuel supply, the method comprising:
a) adding a fuel cell system powered by the fuel supply; and
b) replacing the driveshaft with a retrofit driveshaft that includes an electric motor; and
c) powering the electric motor solely with the fuel cell system to rotate the retrofit driveshaft; and
d) using a computer controller to control the electric motor so that the electric motor can rotate the driveshaft alone or with the internal combustion engine, depending on vehicle traction drive demands.

20. The method of claim 19, wherein the fuel cell system uses a Solid Oxide Fuel Cell (SOFC).

21. The method of claim 20, wherein the exhaust from internal combustion engine provides heat to the SOFC.

22. The method of claim 19, including feeding an exhaust from the fuel cell system to an intake of the internal combustion engine.
